(19) United States
(12) Patent Application Publication
(10) Pub. No.: US 2010/0023767 A1
(43) Pub. Date: Jan. 28, 2010

(54) API for Diffie-Hellman secret agreement

(75) Inventors: Michael D. Downen, Sammamish, WA (US); Shawn Farkas, Kirkland, WA (US); Charles William Kaufman, Sammamish, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/804,357

(22) Filed: May 18, 2007

(51) Int. Cl. H04L 9/32

(52) U.S. Cl. 713/171

(57) ABSTRACT

Various technologies and techniques are disclosed for implementing a Diffie-Hellman secret agreement. An application programming interface is provided that is operable to allow a first computer to generate a Diffie-Hellman secret agreement for communicating securely with a second computer over an insecure channel. A get public key operation is performed upon receiving a request to perform the get public key operation. The get public key operation gets a public key of the first computer. A retrieval operation is performed upon receiving a request to perform the retrieval operation. The retrieval operation retrieves the Diffie-Hellman secret agreement upon supplying a public key of the second computer.

### BACKGROUND

In the world of computers, there are various ways for computers to communicate with one another, both insecurely and securely. For example, many communications occur over insecure channels, such as by sending data through third party service providers and other channels over the Internet that are insecure and/or that you have no control over. Information that is sent over insecure channels can be intercepted and interpreted by people who set out to do so. Some computers communicate using secure channels, such as an internal network that is secured by various security features that allow computers participating in the network to communicate with one another securely. As another example, virtual private networks can be established to allow computers to have a secure channel for communicating information. Some computers communicate using one of various encryption mechanisms, where the parties on each end know how to encode and decode the information.

For example, the Diffie-Hellman secret agreement is a cryptographic protocol that has been around for quite some time to allow two parties that have no prior knowledge of each other to jointly establish a shared secret key over insecure channels. Each computer generates a key pair that has a public and private key. Each computer then exchanges their public key with the other. The first computer can then use its private key and the public key of the other to generate a unique key that serves as the “secret agreement”. The second computer does the same. The secret agreement that each computer generates ends up having a same mathematical result. This secret agreement can then be used to encrypt and protect the integrity of communications on the insecure channels between the computers. The implementations of the Diffie-Hellman secret agreement that exist today require an extensive amount of work on the part of the user or programmer to make use of the algorithm for communications.

### SUMMARY

Various technologies and techniques are disclosed for implementing a Diffie-Hellman secret agreement. An application programming interface is provided that is operable to allow a first computer to generate a Diffie-Hellman secret agreement for communicating securely with a second computer over an insecure channel. A get public key operation is performed upon receiving a request to perform the get public key operation. The get public key operation gets a public key of the first computer. A retrieval operation is performed upon receiving a request to perform the retrieval operation. The retrieval operation retrieves the Diffie-Hellman secret agreement upon supplying a public key of the second computer.

In one implementation, the application programming interface allows the Diffie-Hellman secret agreement to be generated after performance of just these two required operations and acceptance of one or more default parameters.

In one implementation, a class is provided for calculating a Diffie-Hellman secret agreement, the class including a constructor for creating an instance of the class and for generating a key pair. The class also includes a public method for getting a public key and a public method for deriving key material.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of a Diffie-Hellman secret agreement application of one implementation operating on the computer system of FIG. 1.

FIG. 3 is a high-level process flow diagram for one implementation of the system of FIG. 1.

FIG. 4 is a process flow diagram for one implementation of the system of FIG. 1 illustrating the stages involved in providing an application programming interface for generating a Diffie-Hellman secret agreement.

FIG. 5 is a process flow diagram for one implementation of the system of FIG. 1 illustrating the stages involved in serializing and/or de-serializing a public key.

FIG. 6 is a process flow diagram for one implementation of the system of FIG. 1 illustrating the stages involved in providing a class for implementing a Diffie-Hellman secret agreement.

FIG. 7 is a diagram illustrating an exemplary abstract base class for a Diffie-Hellman secret agreement of one implementation.

FIGS. 8A-8E are diagrams illustrating an exemplary class for implementing a Diffie-Hellman secret agreement of one implementation.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as an application programming interface for implement a Diffie-Hellman secret agreement, but the system also serves other purposes in addition to these. In one implementation, one or more of the techniques described herein can be implemented as features within an operating system such as MICROSOFT® WINDOWS®, from a framework program such as MICROSOFT®.NET Framework, or from any other type of program or service that provides application programming interfaces for allowing computers to communicate with each other.

In one implementation, an application programming interface (API) is provided for generating a Diffie-Hellman secret agreement. The API allows a first computer to generate a Diffie-Hellman secret agreement upon calling just two required operation of the API and accepting the default parameters. The first required operation is a get public key operation that gets the public key of the first computer. The second required operation is a retrieval operation that retrieves the secret agreement (e.g. the secret key) after supplying the public key that was provided by the second computer. The second computer can use the API to generate the secret agreement on its end too. The secret agreement is then used in communications sent between the first computer and the second computer. The default parameters can be further customized as desired upon setting various properties of the API.

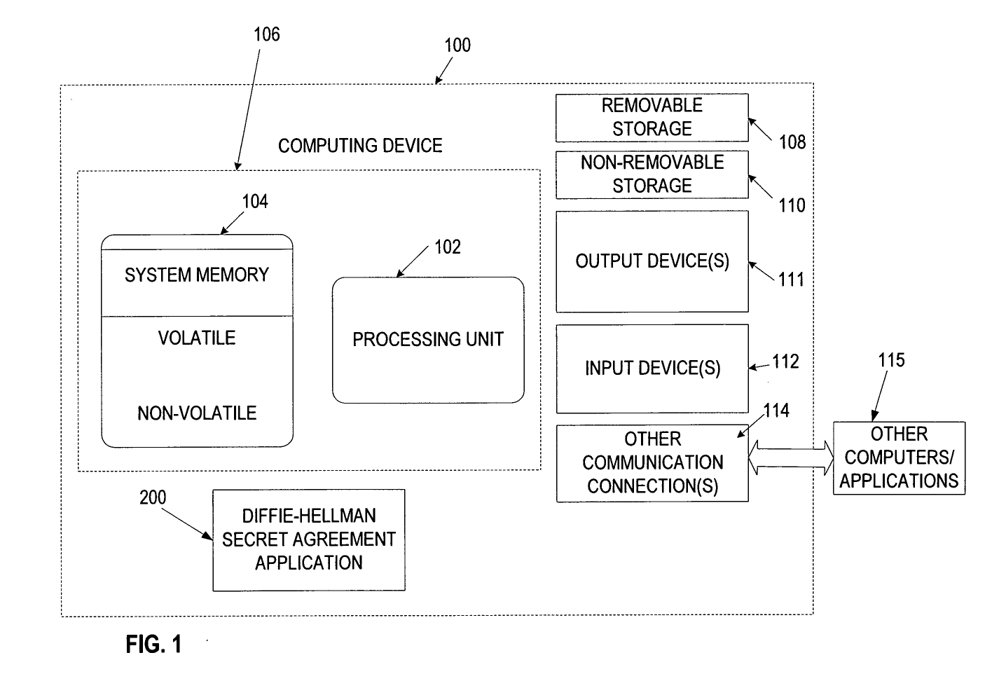

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

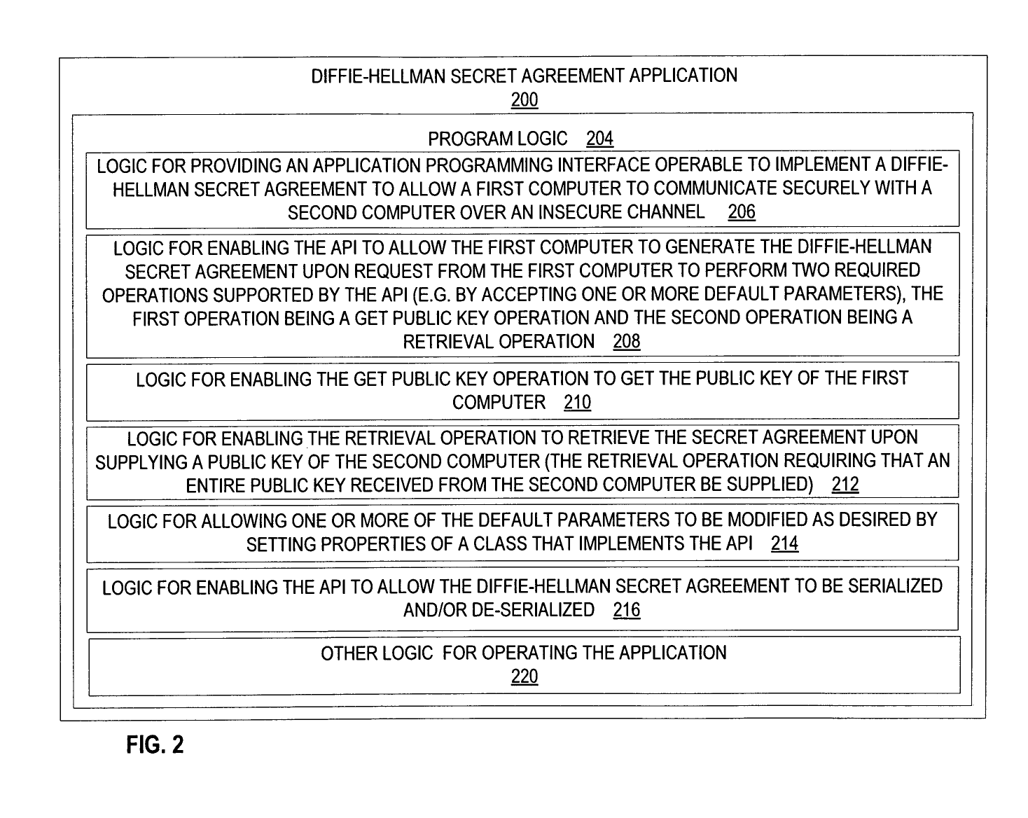

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes Diffie-Hellman secret agreement application 200. Diffie-Hellman secret agreement application 200 will be described in further detail in FIG. 2.

Turning now to FIG. 2 with continued reference to FIG. 1, a Diffie-Hellman secret agreement application 200 operating on computing device 100 is illustrated. Diffie-Hellman secret agreement application 200 is one of the application programs that reside on computing device 100. However, it will be understood that Diffie-Hellman secret agreement application 200 can alternatively or additionally be embodied as computer-executable instructions on one or more computers and/or in different variations than shown on FIG. 1. Alternatively or additionally, one or more parts of Diffie-Hellman secret agreement application 200 can be part of system memory 104, on other computers and/or applications 115, or other such variations as would occur to one in the computer software art.

Diffie-Hellman secret agreement application 200 includes program logic 204, which is responsible for carrying out some or all of the techniques described herein. Program logic 204 includes logic for providing an application programming interface (API) operable to implement a Diffie-Hellman secret agreement to allow a first computer to communicate securely with a second computer over an insecure channel 206; logic for enabling the API to allow the first computer to generate the Diffie-Hellman secret agreement upon request from the first computer to perform two required operations supported by the API (e.g. by accepting one or more default parameters), the first operation being a get public key operation and the second operation being a retrieval operation 208; logic for enabling the get public key operation to get the public key of the first computer 210; logic for enabling the retrieval operation to retrieve the secret agreement upon supplying a public key of the second computer (the retrieval operation requiring that an entire public key received from the second computer be supplied) 212; logic for allowing one or more of the default parameters to be modified as desired by setting properties of a class that implements the API 214; logic for enabling the API to allow the Diffie-Hellman secret agreement to be serialized and/or de-serialized 216; and other logic for operating the application 220. In one implementation, program logic 204 is operable to be called programmatically from another program, such as using a single call to a procedure in program logic 204.

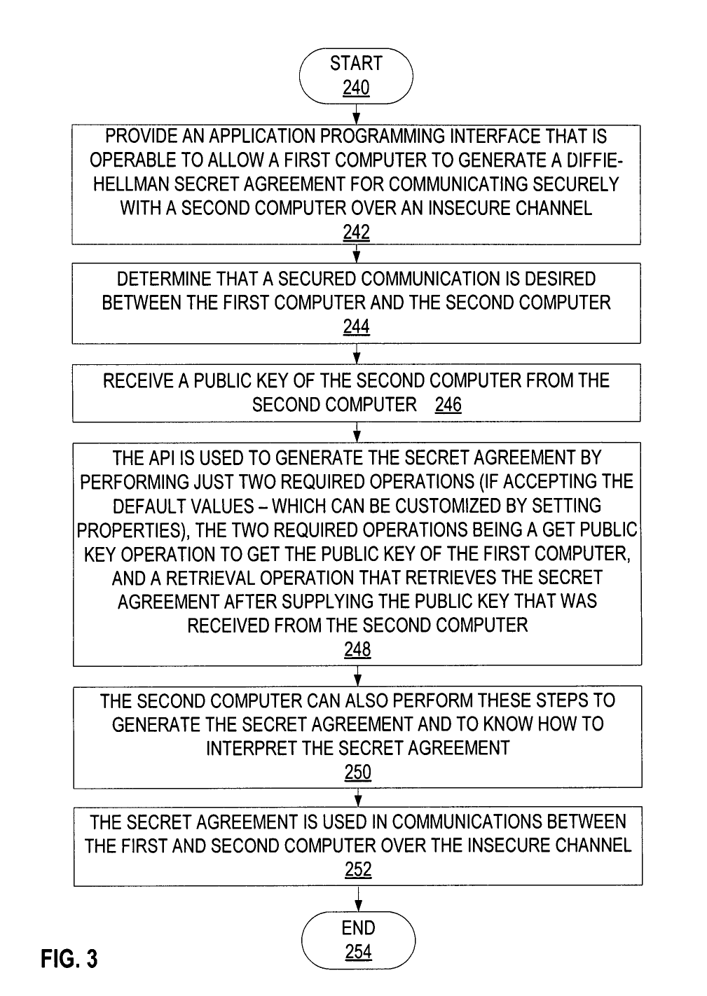

Turning now to FIGS. 3-6 with continued reference to FIGS. 1-2, the stages for implementing one or more implementations of Diffie-Hellman secret agreement application 200 are described in further detail. FIG. 3 is a high level process flow diagram for Diffie-Hellman secret agreement application 200. In one form, the process of FIG. 3 is at least partially implemented in the operating logic of computing device 100. The process begins at start point 240 with providing an application programming interface that is operable to allow a first computer to generate a Diffie-Hellman secret agreement for communicating securely with a second computer over an insecure channel (stage 242). Determine that a secured communication is desired between the first computer and the second computer (stage 244). The first computer receives a public key of the second computer from the second computer (stage 246). The API is used to generate the secret agreement by performing just two required operations (if accepting the default values—which can be customized by setting properties) (stage 248). The two required operations include a get public key operation to get the public key of the first computer, and a retrieval operation that retrieves the secret agreement after supplying the public key that was received from the second computer (stage 248). The second computer can also perform these steps to generate the secret agreement and to know how to interpret the secret agreement (stage 250). The secret agreement is used in communications between the first and second computer over the insecure channel (stage 252). The process ends at end point 254.

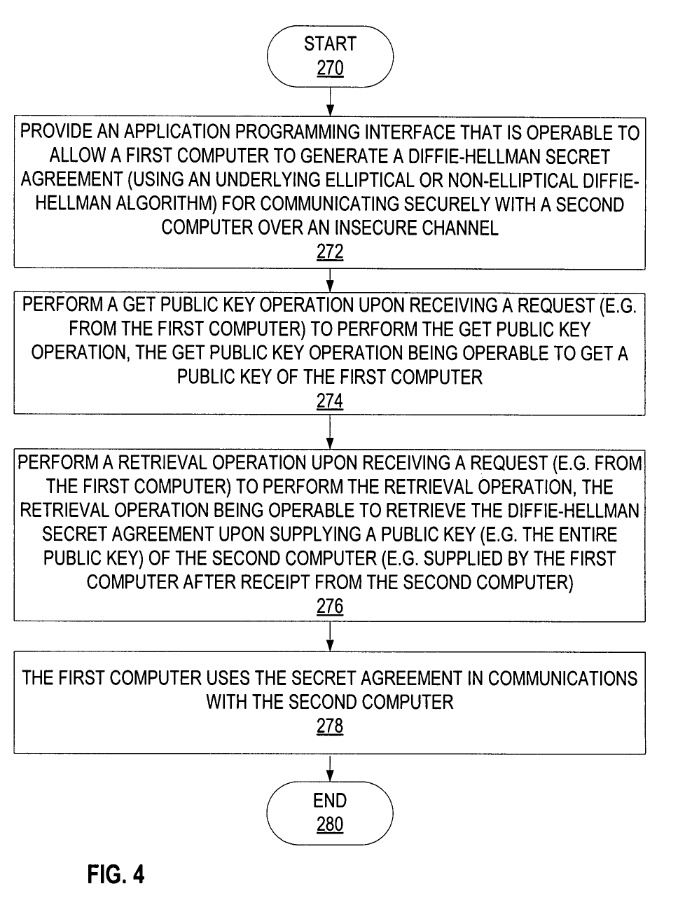

FIG. 4 illustrates one implementation of the stages involved in providing an application programming interface for generating a Diffie-Hellman secret agreement. In one form, the process of FIG. 4 is at least partially implemented in the operating logic of computing device 100. The process begins at start point 270 with providing an application programming interface that is operable to allow a first computer to generate a Diffie-Hellman secret agreement (using an underlying elliptical or non-elliptical Diffie-Hellman algorithm) for communicating securely with a second computer over an insecure channel (stage 272). A get public key operation is performed upon receiving a request (e.g. from the first computer) to perform the get public key operation, the get public key operation being operable to get a public key of the first computer (stage 274). A retrieval operation is performed upon receiving a request (e.g. from the first computer) to perform the retrieval operation, the retrieval operation being operable to retrieve the Diffie-Hellman secret agreement upon supplying a public key (e.g. the entire public key) of the second computer (e.g. supplied by the first computer after receipt from the second computer) (stage 276). The first computer uses the secret agreement in communications with the second computer (stage 278). The process ends at end point 280.

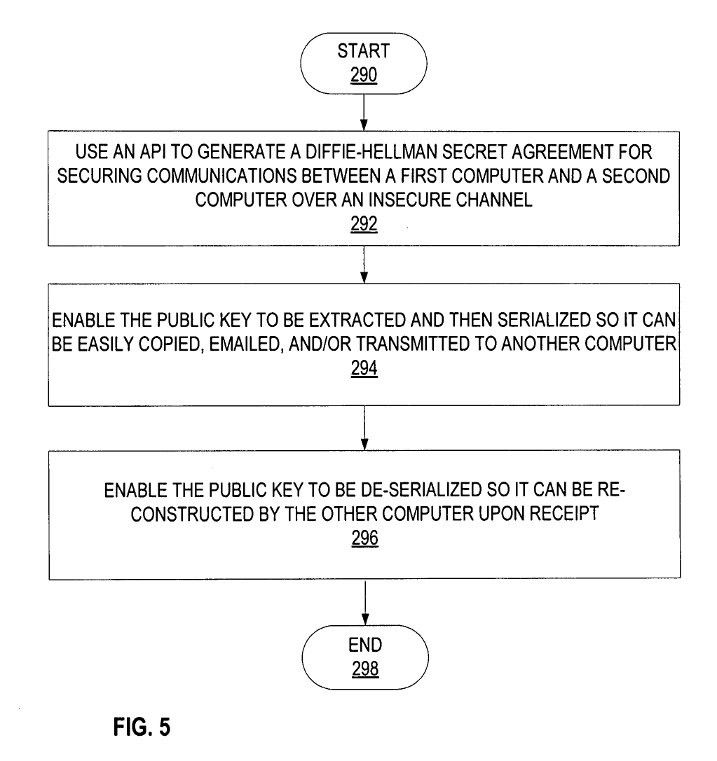

FIG. 5 illustrates one implementation of the stages involved in serializing and/or de-serializing a public key. In one form, the process of FIG. 5 is at least partially implemented in the operating logic of computing device 100. The process begins at start point 290 with using an API to generate a Diffie-Hellman secret agreement for securing communications between a first computer and a second computer over an insecure channel (stage 292). The system enables the public key to be extracted and then serialized so it can be easily copied, emailed, and/or transmitted to another computer (stage 294). The system enables the public key to be de-serialized so it can be re-constructed by the other computer upon receipt (stage 296). The process ends at end point 298.

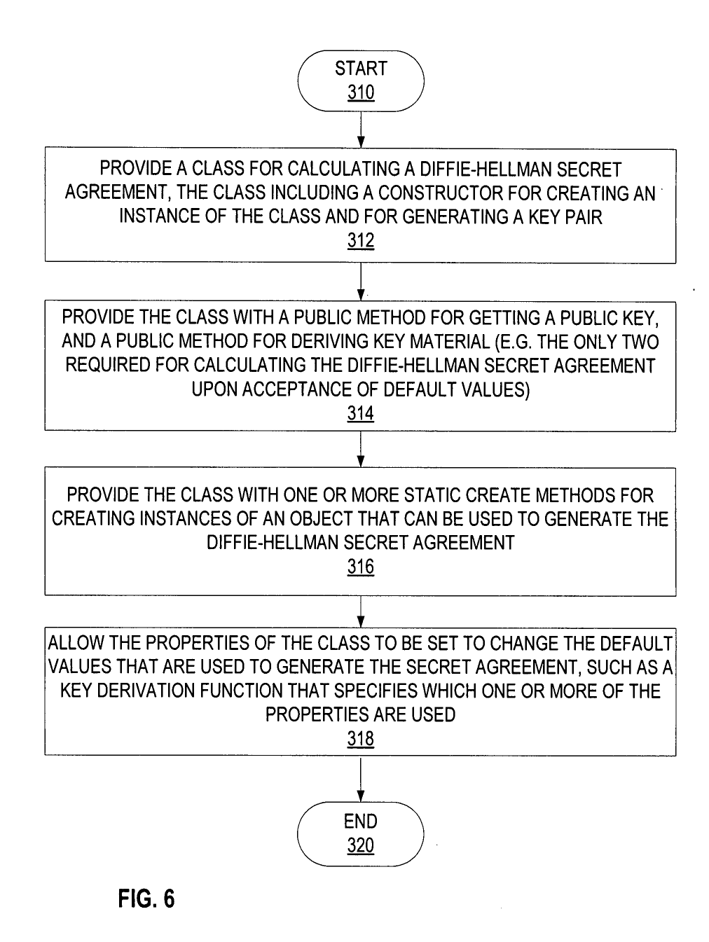

FIG. 6 illustrates one implementation of the stages involved in providing a class for implementing a Diffie-Hellman secret agreement. In one form, the process of FIG. 6 is at least partially implemented in the operating logic of computing device 100. The process begins at start point 310 with providing a class for calculating a Diffie-Hellman secret agreement, the class including a constructor for creating an instance of the class and for generating a key pair (stage 312). The class is provided with a public method for getting a public key, and a public method for deriving key material (stage 314). In one implementation, these two methods are the only two methods that are required to be executed in order to calculate the Diffie-Hellman secret agreement. The class is provided with one or more static create methods for creating instances of an object that can be used to generate the Diffie-Hellman secret agreement (stage 316). The properties of the class can be set to specify parameters that are used to generate the secret agreement, such as a key derivation function that specifies which one or more of the properties are used (stage 318). The process ends at end point 320.

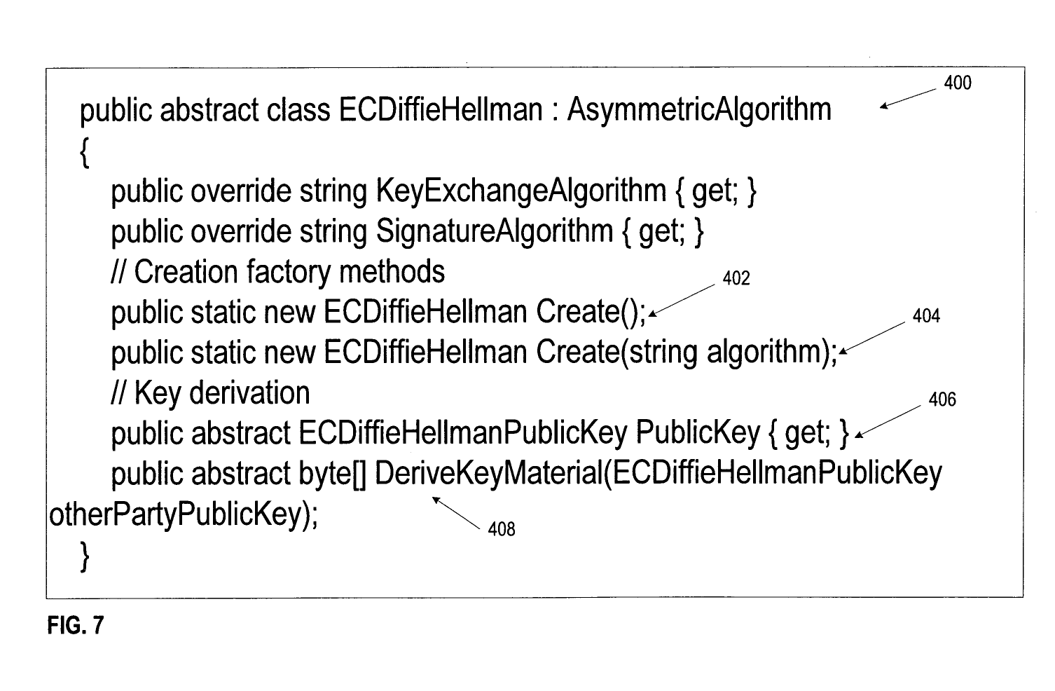

FIG. 7 is a diagram illustrating an exemplary abstract base class 400 for a Diffie-Hellman secret agreement of one implementation. The abstract base class contains various public properties and methods. For example, the Create( ) method 402 returns an instance of the default implementation of this class, which is ECDiffieHellmanCng. The Create(string name) method 404 returns a new instance of ECDiffieHellmanCng when passed the strings “DiffieHellman” (or its fully qualified name), “ECDiffieHellmanCng” (or its fully qualified name). The PublicKey property 406 gets the public key associated with this instance of the class. The method DeriveKeyMaterial 408 returns the key material from the key exchange with the other party's public key.

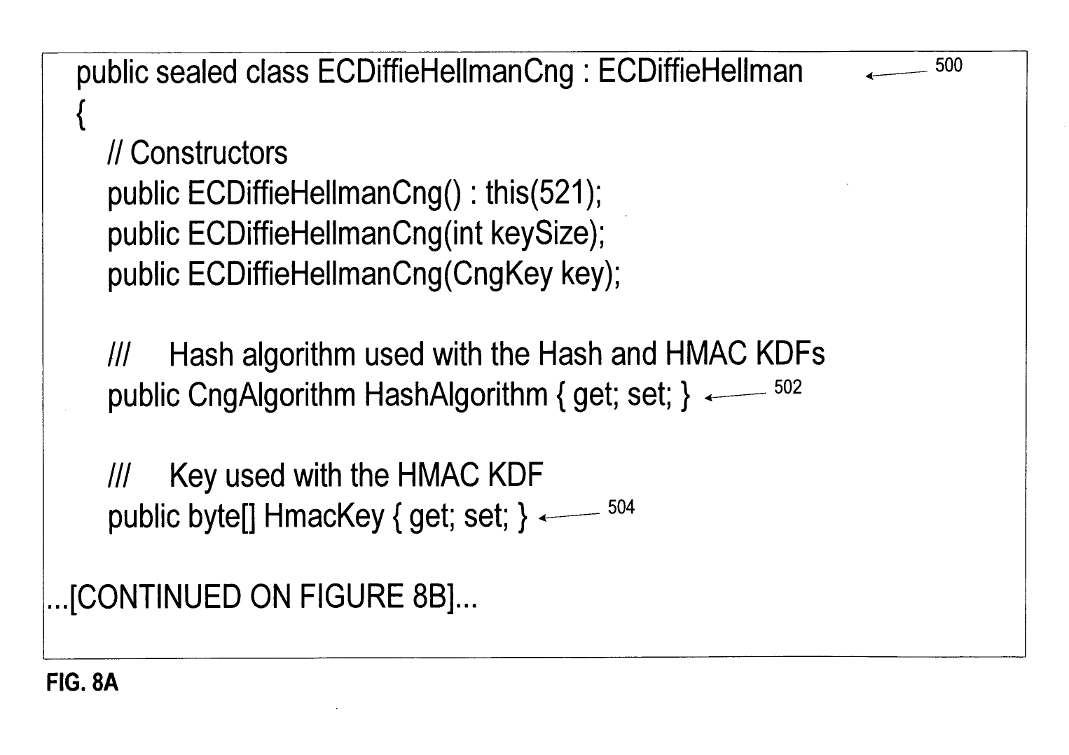

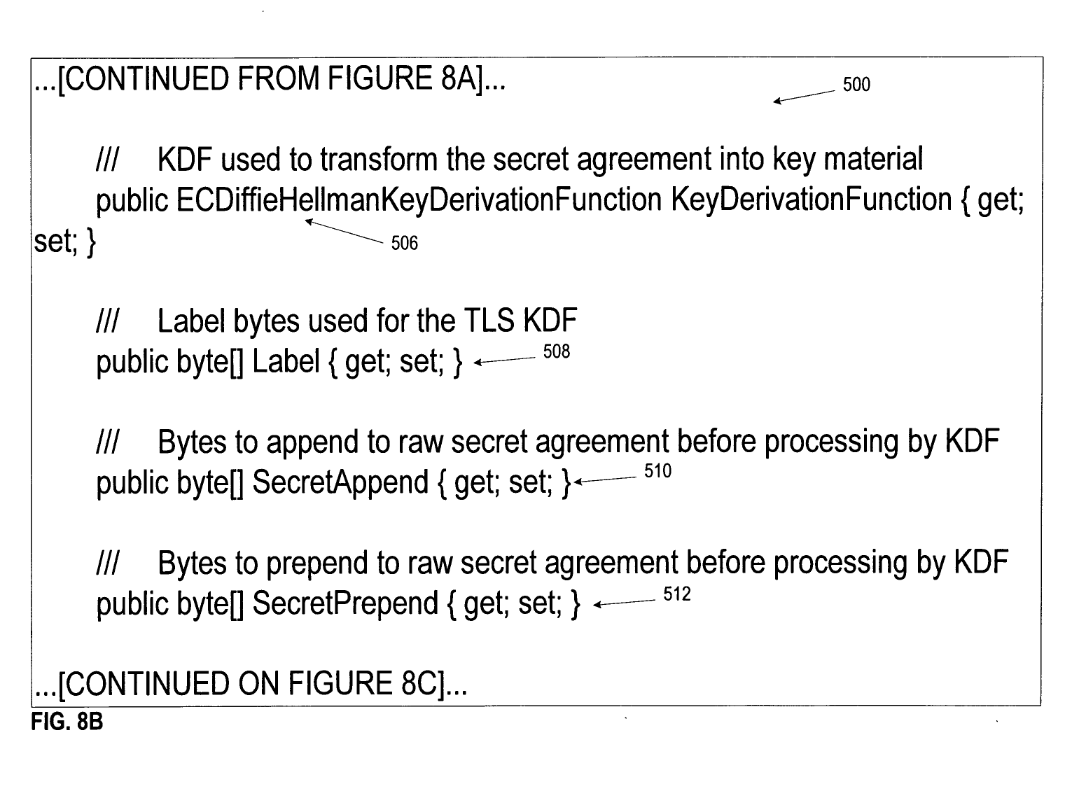

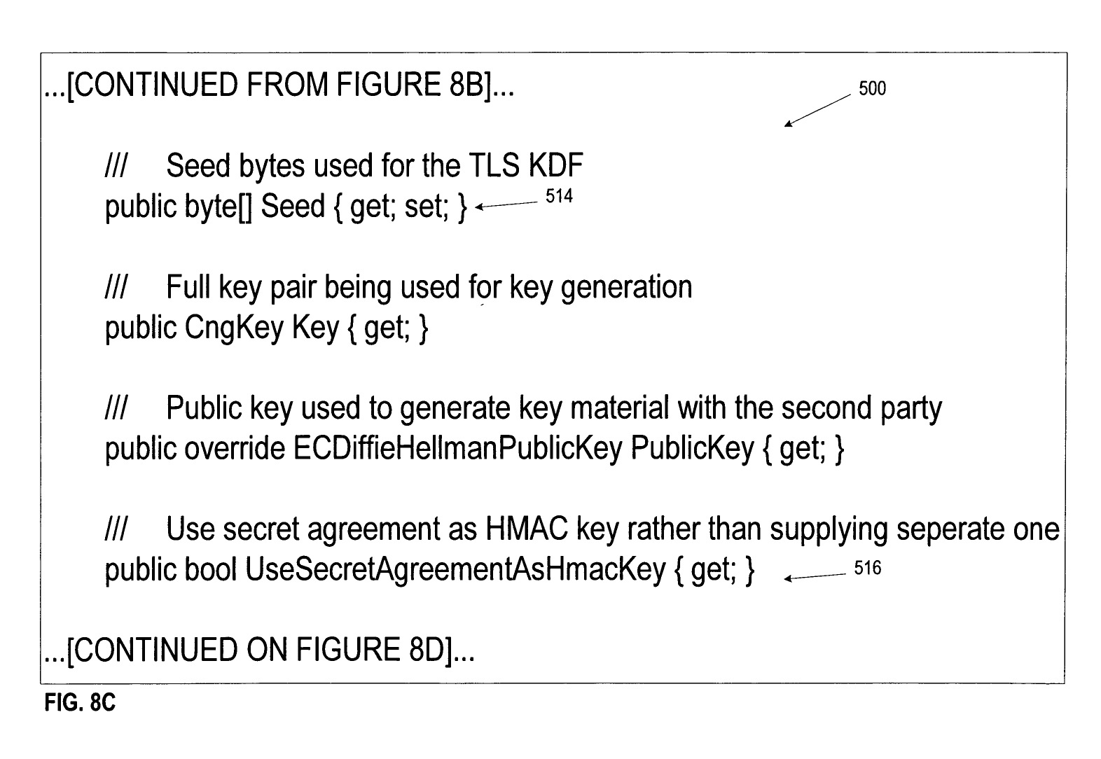

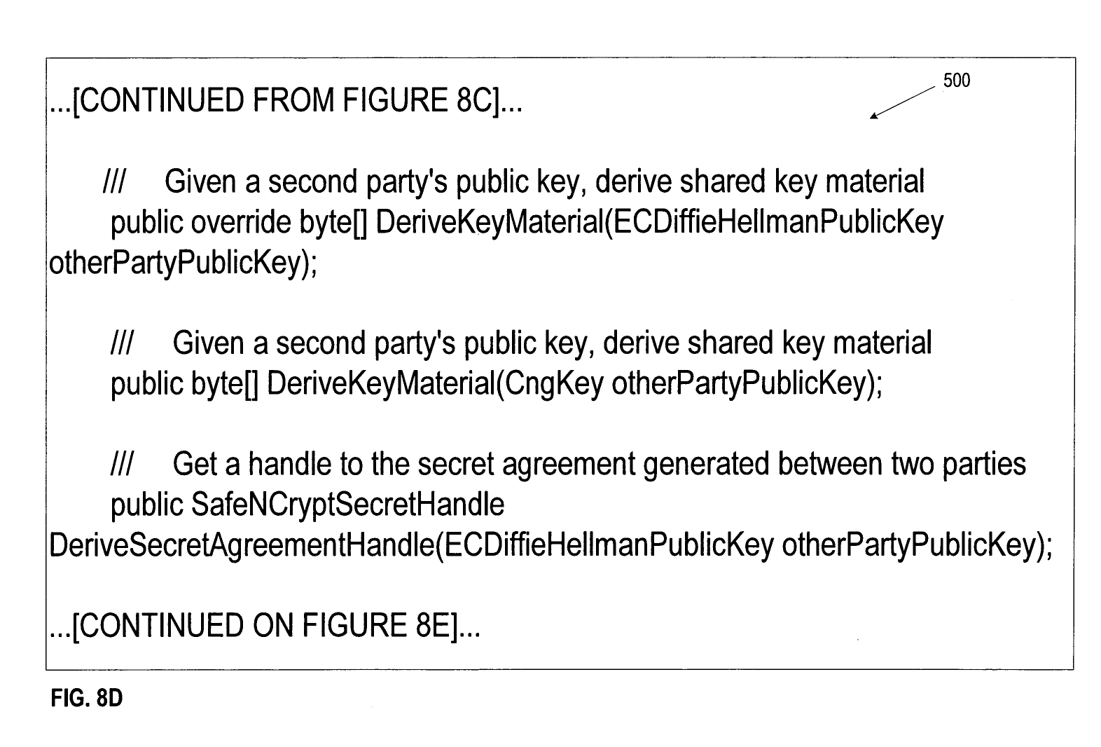

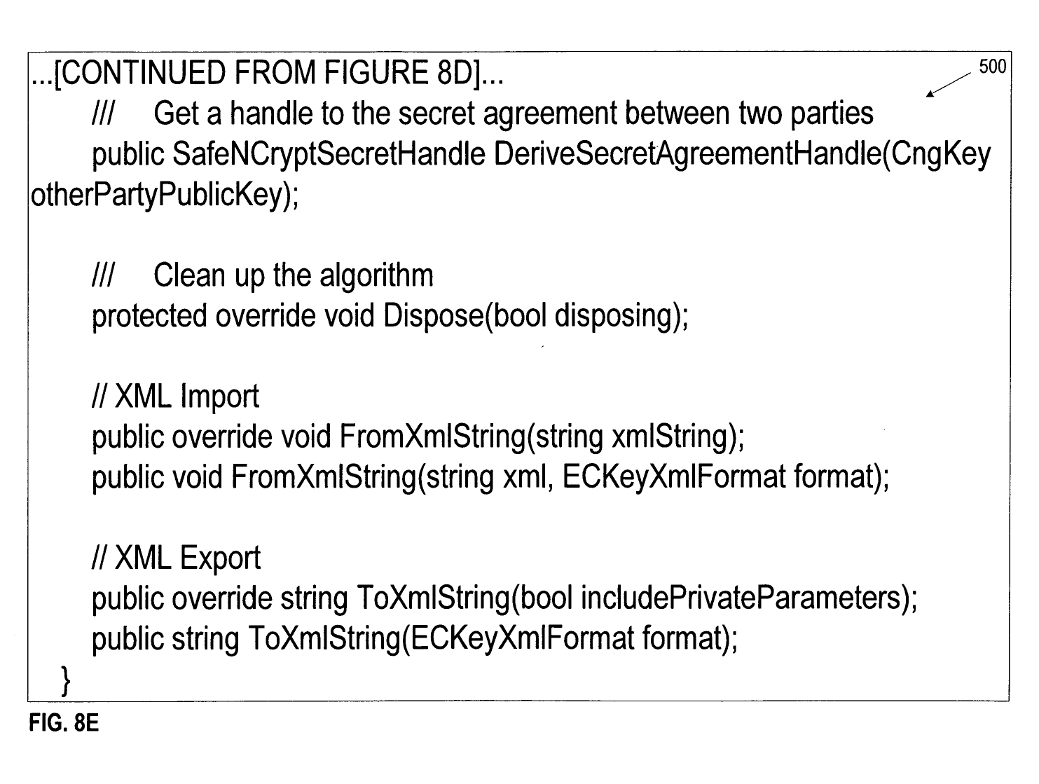

FIGS. 8A-8E are diagrams illustrating an exemplary class 500 for implementing a Diffie-Hellman secret agreement of one implementation. Class 500 contains various properties and methods. An explanation of the purpose of each property and method is shown in the code comments above the respective line. To illustrate a few examples of this class, a few of them will now be discussed herein. As shown in FIG. 8A, the ECDiffieHellmanCng exemplary class includes a property called HashAlgorithm 502 that specifies the hash algorithm to use when generating key material. In one implementation, this property only applies when the ECDiffieHellmanKeyMaterialGeneration Method.Hash value is set in the KeyMaterialGenerationMethod property. In one implementation, this method accepts at least MD2, MD4, MD5, SHA1, SHA256, SHA384, and SHA512, and defaults to SHA256.

The HmacKey property 504 specifies the HMAC key to use when generating key material. In one implementation, this property only applies when the ECDiffieHellmanKey MaterialGenerationMethod.Hmac value is set in the KeyMaterialGenerationMethod property. This property is null by default. Turning now to FIG. 8B, the KeyDerivationFunction 506 is used to transform the secret agreement into key material. The Label property 508 is used as the label value when generating key material. In one implementation, this property only applies when the ECDiffieHellmanKeyMaterialGenerationMethod.Tls value is set in the KeyMaterialGenerationMethod property. It is null by default. The SecretAppend property 510 specifies a value to be appended to the secret agreement when generating key material. In one implementation, this property only applies when the ECDiffieHellmanKeyMaterialGenerationMethod.Hash or ECDiffie HellmanKey MaterialGenerationMethod.Hmac values are set in the KeyMaterial Generation Method property. It is null by default. The SecretPrepend property 512 specifies a value to be prepended to the secret agreement when generating key material. In one implementation, this property only applies when the ECDiffie HellmanKeyMaterialGeneration Method.Hash or ECDiffieHellmanKeyMaterial GenerationMethod.Hmac values are set in the KeyMaterialGeneration Method property. It is null by default.

Turning now to FIG. 8C, the Seed property 514 is used as the seed value when generating key material. In one implementation, this property only applies when the ECDiffieHellmanKeyMaterialGenerationMethod.Tls value is set in the KeyMaterialGenerationMethod property. It is null by default. When the UseSecretAgreementAsHmacKey property 516 is set to true, the secret agreement is used as a HMAC key to generate key material. In one implementation, this property only applies when the ECDiffieHellmanKeyMaterialGeneration Method.Hmac value is set in the KeyMaterialGenerationMethod property. It is false by default.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A method for providing an application programming interface for implementing a Diffie-Hellman secret agreement comprising the steps of:
providing an application programming interface that is operable to allow a first computer to generate a Diffie-Hellman secret agreement for communicating securely with a second computer over an insecure channel;
performing a get public key operation upon receiving a request from the first computer to perform the get public key operation, the get public key operation being operable to get a public key of the first computer; and
performing a retrieval operation upon receiving a request from the first computer to perform the retrieval operation, the retrieval operation being operable to retrieve the Diffie-Hellman secret agreement upon supplying a public key of the second computer.

2. The method of claim 1, wherein prior to performing the retrieval operation, the first computer receives the public key of the second computer from the second computer and supplies the public key of the second computer to the retrieval operation.

3. The method of claim 1, wherein the retrieval operation requires that an entire public key of the second computer be supplied.

4. The method of claim 1, wherein one or more parameters that are used by the application programming interface to generate the secret agreement can be modified by setting properties of a class that implements the application programming interface.

5. The method of claim 1, wherein the secret agreement can be generated using just the get public key operation and the retrieval operation by using default values that do not have to change unless a user wants to customize one or more parameters used for generating the secret agreement.

6. The method of claim 1, wherein the second computer uses a same application programming interface for communicating securely over the insecure channel.

7. The method of claim 1, wherein the application programming interface can be used with an underlying elliptical curve Diffie-Hellman secret agreement algorithm.

8. The method of claim 1, wherein the application programming interface can be used with an underlying non-elliptical curve Diffie-Hellman secret agreement algorithm.

9. A computer-readable medium having computer-executable instructions for causing a computer to perform the steps recited in claim 1.

10. A computer-readable medium having computer-executable instructions for causing a computer to perform steps comprising:
provide an application programming interface operable to implement a Diffie-Hellman secret agreement to allow a first computer to communicate securely with a second computer over an insecure channel, the application programming interface being operable to allow the first computer to generate the Diffie-Hellman secret agreement upon request from the first computer to perform two required operations supported by the application programming interface by accepting one or more default parameters, the first operation being a get public key operation that gets a public key of the first computer, the second operation being a retrieval operation for retrieving the secret agreement upon supplying a public key of the second computer.

11. The computer-readable medium of claim 10, wherein one or more default parameters can be modified as desired by setting properties of a class that implements the application programming interface.

12. The computer-readable medium of claim 10, wherein the retrieval operation requires that an entire public key of the second computer be supplied.

13. The computer-readable medium of claim 10, wherein the application programming interface is operable to allow the Diffie-Hellman secret agreement to be serialized.

14. The computer-readable medium of claim 10, wherein the application programming interface is operable to allow the Diffie-Hellman secret agreement to be de-serialized.

15. A method for implementing a Diffie-Hellman secret agreement comprising the steps of:
providing a class for calculating a Diffie-Hellman secret agreement, the class including a constructor for creating an instance of the class and for generating a key pair, the class being operable to calculate the Diffie-Hellman secret agreement upon performance of just two methods upon acceptance of default values, the two methods comprising:
a public method for getting a public key; and
a public method for deriving key material.

16. The method of claim 15, wherein the class has one or more static create methods for creating instances of an object that can be used to generate the Diffie-Hellman secret agreement.

17. The method of claim 15, wherein the class has a plurality of properties that can be set to change the default values that are used to generate the secret agreement.

18. The method of claim 17, wherein one of the plurality of properties specifies a key derivation function.

19. The method of claim 18, wherein the specified key derivation function determines which one or more of the plurality of properties are used.

20. A computer-readable medium having computer-executable instructions for causing a computer to perform the steps recited in claim 15.
